(19) United States
(12) Patent Application Publication
(10) Pub. No.: US 2026/0155981 A1
(43) Pub. Date: Jun. 4, 2026

(54) AUTOMATED PREDETERMINED CHANGE CONTROL PLAN (PCCP) EXECUTION ENGINE

(71) Applicant: George William Bickerstaff, III, Greenwich, CT (US)

(72) Inventor: George William Bickerstaff, III, Greenwich, CT (US)

(21) Appl. No.: 19/455,438

(22) Filed: Jan. 21, 2026

(51) Int. Cl. H04L 9/32

(52) U.S. Cl. CPC H04L 9/3226

(57) ABSTRACT

An automated predetermined change control plan execution engine enforces hardware-isolated, regulator-authorized modification of artificial intelligence models. The system monitors performance, executes pre-approved update protocols, blocks unauthorized changes, and maintains immutable audit records. Continuous model improvement is enabled while preserving regulatory compliance and operational safety.

### TECHNICAL FIELD

The present invention relates to computer-implemented systems for lifecycle governance of artificial intelligence models deployed in regulated environments.

More specifically, the invention relates to hardware-enforced execution systems that automatically control, validate, and authorize post-deployment modification of artificial intelligence models in accordance with a predetermined change control plan.

The invention enables continuous model improvement while maintaining regulatory compliance, auditability, and operational safety.

### BACKGROUND

Artificial intelligence models deployed in clinical, diagnostic, and other regulated decision-making systems are subject to performance drift caused by changes in data distributions, evolving clinical practices, hardware variability, and population shifts.

Regulatory frameworks permit controlled post-deployment modification of such models when changes are predefined, validated, and constrained within an approved predetermined change control plan.

Existing approaches rely primarily on manual governance processes, policy documentation, or software-level monitoring mechanisms that lack deterministic enforcement.

Monitoring-only systems may detect degradation or drift but do not enforce how or whether a model may be modified.

Software-based update pipelines are susceptible to bypass, misconfiguration, or unauthorized intervention, particularly when update logic is co-located with inference software.

These limitations introduce regulatory risk, liability exposure, and uncertainty regarding whether deployed models continue to operate within approved safety boundaries.

Accordingly, there exists a need for a system that not only detects when a model modification may be warranted, but that enforces authorized modification pathways at execution time.

Such a system must be isolated from inference software, cryptographically verifiable, and capable of blocking or rolling back unauthorized or unsafe modifications.

The present invention addresses these deficiencies by providing a hardware-integrated PCCP execution engine that deterministically governs post-deployment model evolution.

### SUMMARY OF THE INVENTION

The disclosed invention provides an automated predetermined change control plan execution engine for artificial intelligence systems deployed in regulated environments.

The execution engine continuously evaluates real-time model performance against validated baseline profiles defined by a regulator-approved predetermined change control plan.

Upon detection of a predefined performance trigger, the engine automatically executes a pre-authorized modification protocol within a hardware-isolated execution environment.

The system prevents any model modification unless cryptographic authorization associated with the predetermined change control plan is verified.

Modification execution is isolated from inference software, and any failure of validation criteria results in deterministic rollback or blocking.

All modification activities, authorization events, and validation outcomes are recorded in immutable audit records suitable for regulatory review, compliance verification, and lifecycle governance.

### Definitions

Authorization Token means a cryptographically verifiable artifact indicating regulatory approval for execution of a specific modification protocol under a predetermined change control plan.

Execution Boundary means a control point at which an artificial intelligence model, model update, or inference output would affect downstream systems, workflows, or decisions.

Hardware-Isolated Controller means a processing component operating within a trusted execution environment and isolated from host operating systems and inference software.

Modification Protocol means a predefined, regulator-authorized sequence of operations for modifying an artificial intelligence model.

Model Version Identifier means a unique identifier cryptographically bound to a specific model architecture, parameters, and training context.

Performance Trigger means a condition defined by a predetermined change control plan that initiates evaluation or modification of a model.

Predetermined Change Control Plan means a regulator-authorized specification defining permissible model modifications, validation criteria, and operational constraints.

Trusted Execution Environment means a hardware-protected execution environment that ensures integrity and confidentiality of operations.

Validation Baseline Profile means a reference profile defining acceptable performance, safety, and operating thresholds.

Violation Signal means a deterministic signal generated when modification criteria or validation requirements are not satisfied.

### BRIEF DESCRIPTION OF THE DRAWINGS

FIG. 1 illustrates PCCP execution architecture.

FIG. 2 illustrates performance trigger detection.

FIG. 3 illustrates authorized modification execution.

FIG. 4 illustrates rollback and blocking.

FIG. 5 illustrates audit and reporting.

### DETAILED DESCRIPTION OF THE DRAWINGS

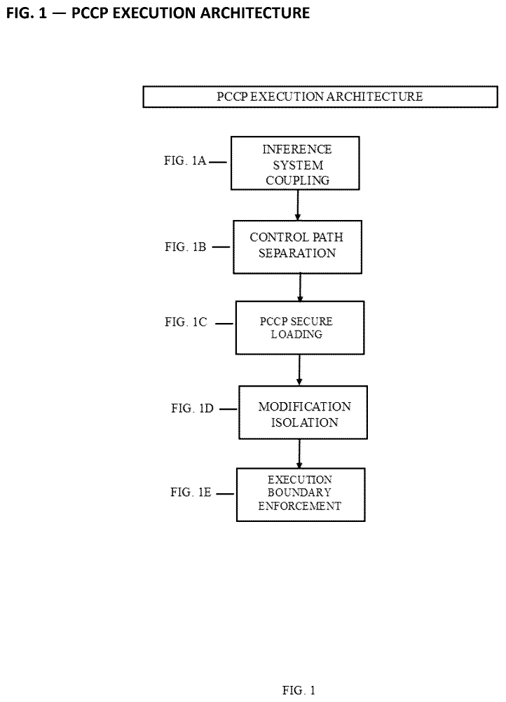

### FIG. 1—PCCP Execution Architecture

FIG. 1A—INFERENCE SYSTEM COUPLING illustrates coupling between an artificial intelligence inference system and a hardware-isolated PCCP execution engine. The coupling permits monitoring of model performance without exposing modification controls to inference software. This establishes a separate governance plane.

FIG. 1B—CONTROL PATH SEPARATION illustrates logical separation between inference execution and modification control pathways. Inference outputs proceed only when no authorized modification is active. This prevents concurrent inference and update operations.

FIG. 1C—PCCP SECURE LOADING illustrates secure loading of predetermined change control plan specifications into protected memory. The loaded plan defines authorized triggers, modification protocols, and validation constraints. Unauthorized alteration is cryptographically prevented.

FIG. 1D—MODIFICATION ISOLATION illustrates isolation of modification execution from host operating systems and application software. All update logic executes within a trusted execution environment. This ensures deterministic and tamper-resistant behavior.

FIG. 1E—EXECUTION BOUNDARY ENFORCEMENT illustrates enforcement of execution boundaries preventing unauthorized model updates from propagating to downstream systems. Unauthorized attempts are intercepted before affecting outputs. The execution boundary serves as a hard lifecycle control point.

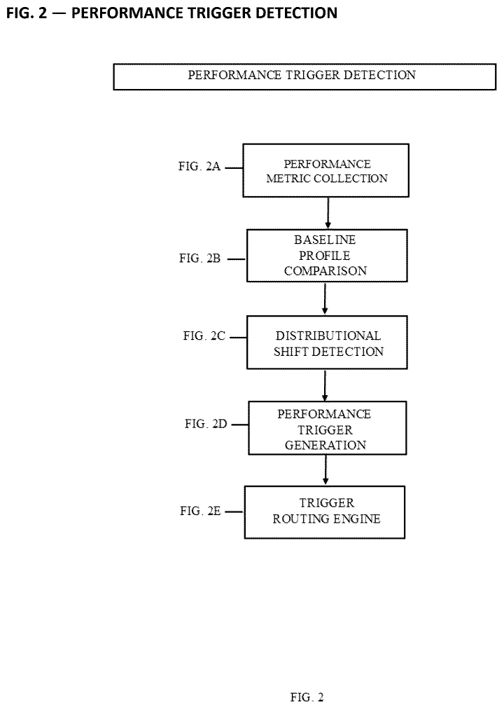

### FIG. 2—Performance Trigger Detection

FIG. 2A—PERFORMANCE METRIC COLLECTION illustrates collection of model performance metrics during deployment. Metrics include accuracy, confidence distributions, and error rates. Collection occurs continuously or at predefined intervals.

FIG. 2B—BASELINE PROFILE COMPARISON illustrates comparison between collected metrics and a validation baseline profile. The baseline defines approved operating ranges. Deviations beyond those ranges are deterministically detected.

FIG. 2C—DISTRIBUTIONAL SHIFT DETECTION illustrates detection of changes in input data characteristics or population behavior. Detection initiates evaluation rather than immediate modification. This prevents premature updates.

FIG. 2D—PERFORMANCE TRIGGER GENERATION illustrates generation of a performance trigger when plan-defined conditions are satisfied. The trigger signals potential eligibility for modification. Execution does not occur without authorization verification.

FIG. 2E—TRIGGER ROUTING ENGINE illustrates routing of the trigger to the hardware-isolated execution engine. Routing preserves separation between detection and execution. This enforces governance discipline.

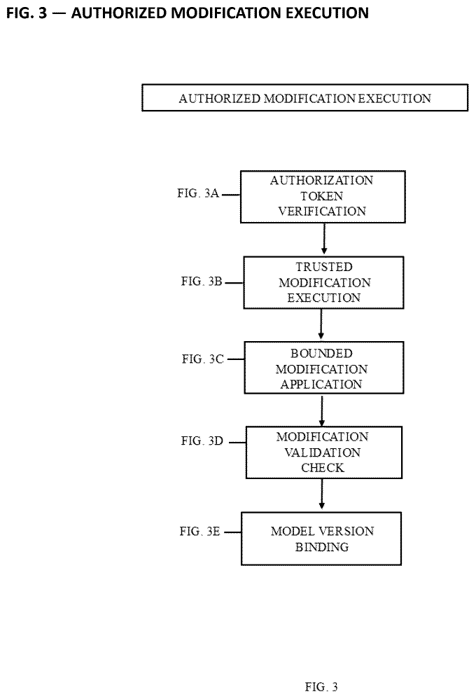

### FIG. 3—AUTHORIZED MODIFICATION EXECUTION

FIG. 3A—AUTHORIZATION TOKEN VERIFICATION illustrates cryptographic verification of an authorization token prior to modification activity. The token is bound to permitted protocols and model identifiers. Verification must succeed to proceed.

FIG. 3B—TRUSTED MODIFICATION EXECUTION illustrates execution of a modification protocol within a trusted execution environment. Operations may include retraining, recalibration, or parameter adjustment. Execution is isolated from inference software.

FIG. 3C—BOUNDED MODIFICATION APPLICATION illustrates application of modification steps constrained by PCCP-defined limits. Modification outside authorized bounds is prevented. Regulatory scope compliance is enforced.

FIG. 3D—MODIFICATION VALIDATION CHECK illustrates validation of the modified model against baseline profiles. Validation occurs prior to deployment. Failure results in immediate rollback.

FIG. 3E—MODEL VERSION BINDING illustrates binding of a new model version identifier upon successful validation. The identifier cryptographically links the model to its modification history. This enables traceability.

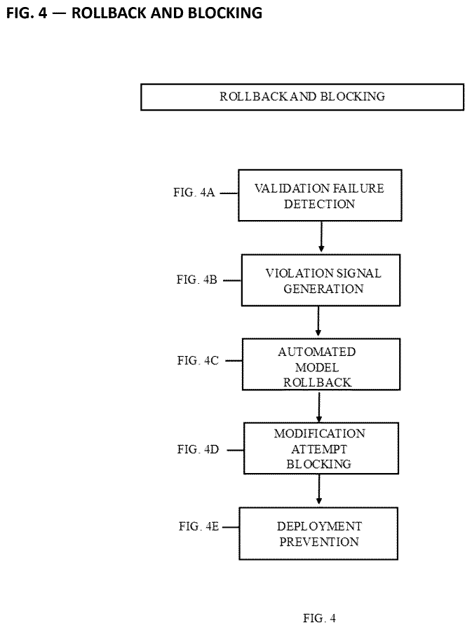

### FIG. 4—Rollback and Blocking

FIG. 4A—VALIDATION FAILURE DETECTION illustrates detection of failure following modification execution. Failure may arise from degraded performance or unmet safety criteria. The response is deterministic.

FIG. 4B—VIOLATION SIGNAL GENERATION illustrates generation of a violation signal upon validation failure. The signal prevents further modification attempts. Safety constraints are enforced.

FIG. 4C—AUTOMATED MODEL ROLLBACK illustrates rollback to a prior validated model version. Rollback occurs without human intervention. The prior model remains operational.

FIG. 4D—MODIFICATION ATTEMPT BLOCKING illustrates blocking of further unauthorized modification attempts. Blocking persists until regulatory conditions are satisfied. System integrity is preserved.

FIG. 4E—DEPLOYMENT PREVENTION illustrates prevention of deployment beyond the execution boundary for unvalidated models. Downstream systems never receive unauthorized outputs. Clinical workflows are protected.

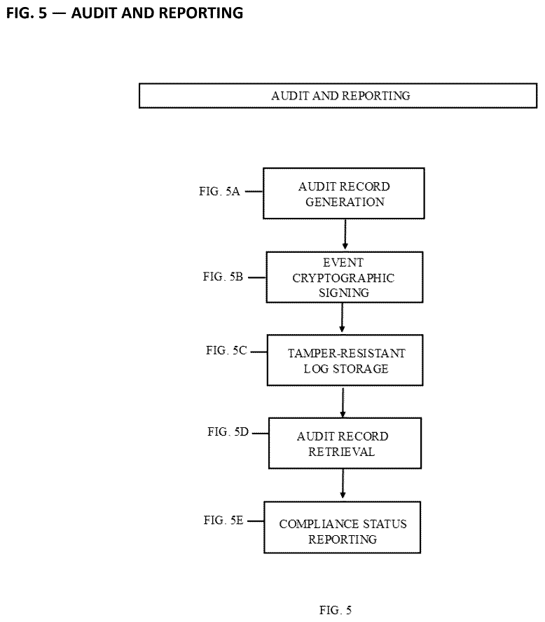

### FIG. 5—Audit and Reporting

FIG. 5A—AUDIT RECORD GENERATION illustrates generation of immutable audit records for each modification event. Records include timestamps, authorization status, and validation outcomes. Records are tamper-resistant.

FIG. 5B—EVENT CRYPTOGRAPHIC SIGNING illustrates cryptographic signing of modification and validation events. Signing ensures integrity and non-repudiation. Regulatory inspection is supported.

FIG. 5C—TAMPER-RESISTANT LOG STORAGE illustrates storage of audit records in a protected log. Logs may be stored locally or remotely. Unauthorized alteration is prevented.

FIG. 5D—AUDIT RECORD RETRIEVAL illustrates retrieval of audit records for regulatory or internal review. Retrieval does not alter original records. Transparency is preserved.

FIG. 5E—COMPLIANCE STATUS REPORTING illustrates reporting of ongoing lifecycle compliance status. Reports may be generated automatically. Continuous oversight is supported.

### EXAMPLES

In one example, a deployed diagnostic model exhibits performance drift beyond an approved threshold. The execution engine verifies authorization and executes a validated retraining protocol within the trusted execution environment. The updated model is deployed only after successful validation.

In another example, an attempt is made to modify a deployed model without a valid authorization token. The hardware-isolated controller blocks execution and generates a violation signal. The event is recorded in the immutable audit log.

1. A system for autonomous modification of an artificial intelligence model deployed in a regulated environment, comprising:
a hardware-isolated controller configured to monitor model performance;
a predetermined change control plan defining authorized modification protocols and performance triggers; and
a processor configured to execute a modification protocol only upon verification of a cryptographic authorization token associated with the predetermined change control plan.

2. A computer-implemented method comprising:
monitoring real-time performance metrics of a deployed artificial intelligence model;
detecting a performance trigger defined by a predetermined change control plan; and
executing, within a trusted execution environment, an authorized modification protocol only after cryptographic authorization is verified.

3. A hardware-locked execution controller configured to prevent modification of an artificial intelligence model unless a cryptographically verifiable authorization token bound to a model version identifier and a permitted modification protocol is validated.

4. The system of claim 1, wherein the performance trigger comprises detection of a degree of distributional shift relative to a validation baseline profile.

5. The method of claim 2, wherein execution of the modification protocol occurs entirely within the trusted execution environment and is isolated from inference software.

6. The system of claim 1, wherein failure of internal validation of a modified model generates a violation signal.

7. The hardware-locked execution controller of claim 3, wherein the authorization token is cryptographically bound to a specific modification protocol and regulatory scope.

8. The system of claim 1, wherein an automated rollback mechanism restores a prior validated model version upon validation failure.

9. The method of claim 2, wherein all modification events, authorization decisions, and validation outcomes are recorded in an immutable audit log.

10. The system of claim 1, wherein unauthorized modification attempts are deterministically blocked at an execution boundary prior to affecting downstream systems.
